(19) United States
(12) Patent Application Publication
(10) Pub. No.: US 2019/0273943 A1
(43) Pub. Date: Sep. 5, 2019

(54) SYSTEMS AND METHODS FOR PERFORMING MOTION COMPENSATION FOR CODING OF VIDEO DATA

(71) Applicant: Sharp Kabushiki Kaisha, Sakai City, Osaka (JP)

(72) Inventors: Jie ZHAO, Camas, WA (US); Seung-Hwan KIM, Camas, WA (US); Christopher Andrew SEGALL, Camas, WA (US); Kiran Mukesh MISRA, Camas, WA (US)

(21) Appl. No.: 16/339,409

(22) PCT Filed: Sep. 8, 2017
(86) PCT No.: PCT/JP2017/032458

§ 371 Date: Apr. 4, 2019

Related U.S. Application Data
(60) Provisional application No. 62/406,396, filed on Oct. 10, 2016.
(60) Provisional application No. 62/440,326, filed on Dec. 29, 2016.

(51) Int. Cl. H04N 19/513; H04N 19/139; H04N 19/33; H04N 19/176

(52) U.S. Cl. CPC H04N 19/521; H04N 19/176; H04N 19/33; H04N 19/139

(57) ABSTRACT

A video coding method may be configured to perform video coding according to one or more of techniques. The method of performing motion compensation comprises: receiving an array of sample values included in a video block, determining motion vector fields for sub-blocks within the video block; and performing a motion compensation process based on the determined motion vector fields.

### TECHNICAL FIELD

This disclosure relates to video coding and more particularly to techniques for performing motion compensation for coding video data.

### BACKGROUND ART

Digital video capabilities can be incorporated into a wide range of devices, including digital televisions, laptop or desktop computers, tablet computers, digital recording devices, digital media players, video gaming devices, cellular telephones, including so-called smartphones, medical imaging devices, and the like. Digital video may be coded according to a video coding standard. Video coding standards may incorporate video compression techniques. Examples of video coding standards include ISO/IEC MPEG-4 Visual and ITU-T H.264 (also known as ISO/IEC MPEG-4 AVC) and High-Efficiency Video Coding (HEVC). HEVC is described in High Efficiency Video Coding (HEVC), Rec. ITU-T H.265 April 2015, which is incorporated by reference, and referred to herein as ITU-T H.265. Extensions and improvements for ITU-T H.265 are currently being considered for development of next generation video coding standards. For example, the ITU-T Video Coding Experts Group (VCEG) and ISO/IEC (Moving Picture Experts Group (MPEG) (collectively referred to as the Joint Video Exploration Team (JVET)) are studying the potential need for standardization of future video coding technology with a compression capability that significantly exceeds that of the current HEVC standard. The Joint Exploration Model 3 (JEM 3), Algorithm Description of Joint Exploration Test Model 3 (JEM 3), ISO/IEC JTC1/SC29/WG11 Document: JVET-C1001v3, May 2016, Geneva, CH, which is incorporated by reference herein, describes the coding features that are under coordinated test model study by the JVET as potentially enhancing video coding technology beyond the capabilities of ITU-T H.265. It should be noted that the coding features of JEM 3 are implemented in JEM reference software maintained by the Fraunhofer research organization. Currently, the updated JEM reference software version 3 (JEM 3.0) is available. As used herein, the term JEM is used to collectively refer to algorithm descriptions of JEM 3 and implementations of JEM reference software.

Video compression techniques enable data requirements for storing and transmitting video data to be reduced. Video compression techniques may reduce data requirements by exploiting the inherent redundancies in a video sequence. Video compression techniques may sub-divide a video sequence into successively smaller portions (i.e., groups of frames within a video sequence, a frame within a group of frames, slices within a frame, coding tree units (e.g., macroblocks) within a slice, coding blocks within a coding tree unit, etc.). Intra prediction coding techniques (e.g., intra-picture (spatial)) and inter prediction techniques (i.e., inter-picture (temporal)) may be used to generate difference values between a unit of video data to be coded and a reference unit of video data. The difference values may be referred to as residual data. Residual data may be coded as quantized transform coefficients. Syntax elements may relate residual data and a reference coding unit (e.g., intra-prediction mode indices, motion vectors, and block vectors). Residual data and syntax elements may be entropy coded. Entropy encoded residual data and syntax elements may be included in a compliant bitstream.

### SUMMARY OF INVENTION

In general, this disclosure describes various techniques for coding video data. In particular, this disclosure describes techniques for performing motion compensation for coding of video data. It should be noted that although techniques of this disclosure are described with respect to ITU-T H.264, ITU-T H.265, and JEM, the techniques of this disclosure are generally applicable to video coding. For example, the coding techniques described herein may be incorporated into video coding systems, (including video coding systems based on future video coding standards) including block structures, intra prediction techniques, inter prediction techniques, transform techniques, filtering techniques, and/or entropy coding techniques other than those included in ITU-T H.265 and JEM. Thus, reference to ITU-T H.264, ITU-T H.265, and/or JEM is for descriptive purposes and should not be construed to limit the scope of the techniques described herein. Further, it should be noted that incorporation by reference of documents herein is for descriptive purposes and should not be construed to limit or create ambiguity with respect to terms used herein. For example, in the case where an incorporated reference provides a different definition of a term than another incorporated reference and/or as the term is used herein, the term should be interpreted in a manner that broadly includes each respective definition and/or in a manner that includes each of the particular definitions in the alternative.

An aspect of the invention is a method of performing motion compensation, the method comprising: receiving an array of sample values included in a video block, determining motion vector fields for sub-blocks within the video block; and performing a motion compensation process based on the determined motion vector fields.

### BRIEF DESCRIPTION OF DRAWINGS

FIG. 1 is a block diagram illustrating an example of a system that may be configured to encode and decode video data according to one or more techniques of this disclosure.

FIG. 2 is a conceptual diagram illustrating a quad tree binary tree partitioning in accordance with one or more techniques of this disclosure.

FIG. 3 is a conceptual diagram illustrating an example of deriving motion vector fields in accordance with one or more techniques of this disclosure.

FIG. 4 is a conceptual diagram illustrating an example of performing overlapped block motion compensation in accordance with one or more techniques of this disclosure.

FIG. 5 is a block diagram illustrating an example of a video encoder that may be configured to encode video data according to one or more techniques of this disclosure.

FIG. 6 is a flowchart illustrating an example of performing motion compensation according to one or more techniques of this disclosure.

FIG. 7 is a conceptual diagram illustrating an example of performing motion compensation according to one or more techniques of this disclosure.

FIG. 8 is a conceptual diagram illustrating an example of performing overlapped block motion compensation according to one or more techniques of this disclosure.

FIG. 9 is a flowchart illustrating an example of performing motion compensation according to one or more techniques of this disclosure.

FIG. 10 is a block diagram illustrating an example of a video decoder that may be configured to decode video data according to one or more techniques of this disclosure.

### DESCRIPTION OF EMBODIMENTS

Video content typically includes video sequences comprised of a series of frames. A series of frames may also be referred to as a group of pictures (GOP). Each video frame or picture may include a plurality of slices or tiles, where a slice or tile includes a plurality of video blocks. As used herein, the term video block may generally refer to an area of a picture, including one or more video components, or may more specifically refer to the largest array of pixel/sample values that may be predictively coded, sub-divisions thereof, and/or corresponding structures. Further, the term current video block may refer to an area of a picture being encoded or decoded. A video block may be defined as an array of pixel values (also referred to as samples) that may be predictively coded. Video blocks may be ordered according to a scan pattern (e.g., a raster scan). A video encoder may perform predictive encoding on video blocks and sub-divisions thereof. Video blocks and sub-divisions thereof may be referred to as nodes. ITU-T H.264 specifies a macroblock including 16×16 luma samples. ITU-T H.265 specifies an analogous Coding Tree Unit (CTU) structure where a picture may be split into CTUs of equal size and each CTU may include Coding Tree Blocks (CTB) having 16×16, 32×32, or 64×64 luma samples. In ITU-T H.265, the CTBs of a CTU may be partitioned into Coding Blocks (CB) according to a corresponding quadtree block structure. According to ITU-T H.265, one luma CB together with two corresponding chroma CBs (e.g., Cr and Cb chroma components) and associated syntax elements are referred to as a coding unit (CU). In ITU-T H.265, a minimum allowed size of a CB may be signaled. In ITU-T H.265, the smallest minimum allowed size of a luma CB is 8×8 luma samples. A CU is associated with a prediction unit (PU) structure defining one or more prediction units (PU) for the CU, where a PU is associated with corresponding reference samples. That is, in ITU-T H.265, the decision to code a picture area using intra prediction or inter prediction is made at the CU level. In ITU-T H.265, a PU may include luma and chroma prediction blocks (PBs), where square PBs are supported for intra prediction and rectangular PBs are supported for inter prediction. Intra prediction data (e.g., intra prediction mode syntax elements) or inter prediction data (e.g., motion data syntax elements) may associate PUs with corresponding reference samples.

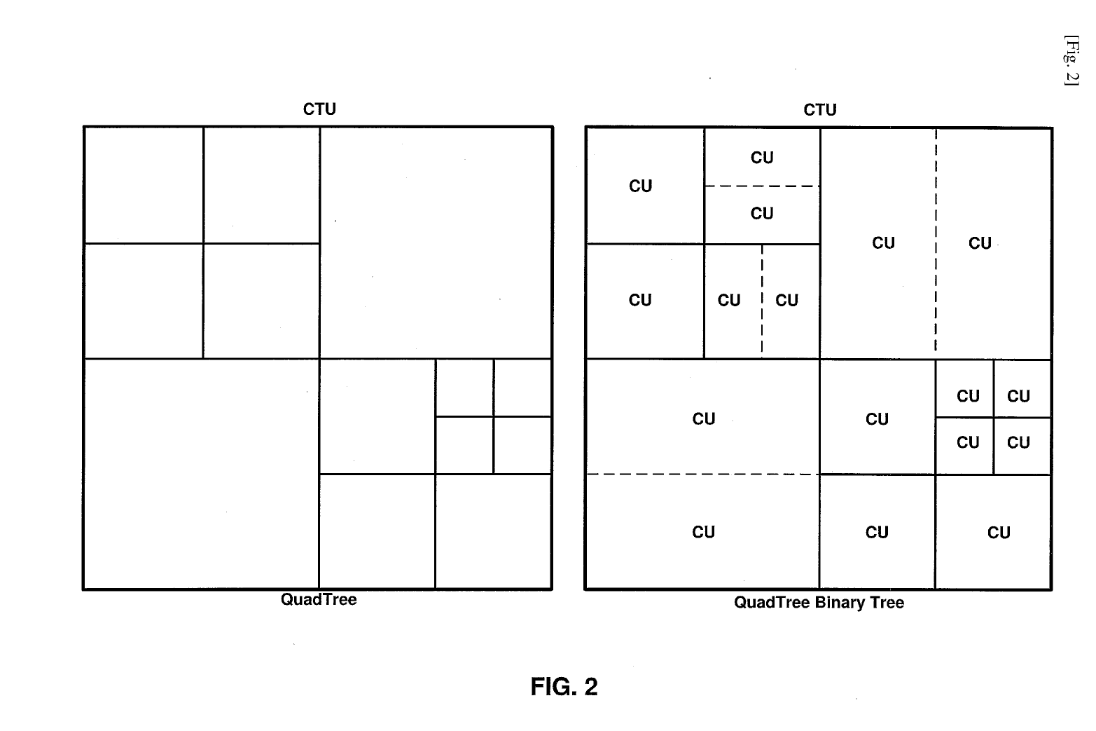

JEM specifies a CTU having a maximum size of 256×256 luma samples. In JEM, CTUs may be further partitioned according a quadtree plus binary tree (QTBT) block structure. In JEM, the QTBT structure enables quadtree leaf nodes to be further partitioned by a binary tree structure. In JEM, the binary tree structure enables quadtree leaf nodes to be divided vertically or horizontally. FIG. 2 illustrates an example of a CTU (e.g., a CTU having a size of 128×128 luma samples) being partitioned into quadtree leaf nodes and quadtree leaf nodes being further partitioned according to a binary tree. That is, in FIG. 2 dashed lines indicate binary tree partitions. Thus, the binary tree structure in JEM enables square and rectangular leaf nodes, where each leaf node includes a Coding Block (CB) for each component of video data. In JEM, CBs may be used for prediction without any further partitioning. Further, in JEM, luma and chroma components may have separate QTBT structures. That is, chroma CBs may be independent of luma partitioning. In JEM, separate QTBT structures are enabled for slices of video data coded using intra prediction techniques.

It should be noted that JEM includes the following parameters for signaling of a QTBT tree:

CTU size: the root node size of a quadtree (e.g., 256×256, 128×128, 64×64, 32×32, 16×16 luma samples);

MinQTSize: the minimum allowed quadtree leaf node size (e.g., 16×16, 8×8 luma samples);

MaxBTSize: the maximum allowed binary tree root node size, i.e., the maximum size of a leaf quadtree node that may be partitioned by binary splitting (e.g., 64×64 luma samples);

MaxBTDepth: the maximum allowed binary tree depth, i.e., the lowest level at which binary splitting may occur (e.g., 3);
MinBTSize: the minimum allowed binary tree leaf node size; i.e., the minimum width or height of a binary leaf node (e.g., 4 luma samples).

A video sampling format, which may also be referred to as a chroma format, may define the number of chroma samples included in a CU with respect to the number of luma samples included in a CU. For example, for the 4:2:0 format, the sampling rate for the luma component is twice that of the chroma components for both the horizontal and vertical directions. As a result, for a CU formatted according to the 4:2:0 format, the width and height of an array of samples for the luma component are twice that of each array of samples for the chroma components. As described above, a CU is typically defined according to the number of horizontal and vertical luma samples. Thus, a 16×16 CU formatted according to the 4:2:0 sample format includes 16×16 samples of luma components and 8×8 samples for each chroma component. Similarly, for a CU formatted according to the 4:2:2 format, the width of an array of samples for the luma component is twice that of the width of an array of samples for each chroma component, but the height of the array of samples for the luma component is equal to the height of an array of samples for each chroma component. Further, for a CU formatted according to the 4:4:4 format, an array of samples for the luma component has the same width and height as an array of samples for each chroma component.

The difference between sample values included in a current CU, or another type of picture area structure, and associated reference samples (e.g., those generated using a prediction) may be referred to as residual data. Residual data may include respective arrays of difference values corresponding to each component of video data (e.g., luma (Y) and chroma (Cb and Cr). Residual data may be in the pixel domain. A transform, such as, a discrete cosine transform (DCT), a discrete sine transform (DST), an integer transform, a wavelet transform, or a conceptually similar transform, may be applied to pixel difference values to generate transform coefficients. It should be noted that in ITU-T H.265, CUs may be further sub-divided into Transform Units (TUs). That is, in ITU-T H.265, an array of pixel difference values may be sub-divided for purposes of generating transform coefficients (e.g., four 8×8 transforms may be applied to a 16×16 array of residual values), for each component of video data, such sub-divisions may be referred to as Transform Blocks (TBs). Currently in JEM, when a QTBT partitioning structure is used, residual values corresponding to a CB are used to generate transform coefficients without further partitioning. That is, in JEM a QTBT leaf node may be analogous to both a PB and TB in ITU-T H.265. Thus, JEM enables rectangular CB predictions for intra and inter predictions. Further, in JEM, a core transform and a subsequent secondary transforms may be applied (in the encoder) to generate transform coefficients. For a video decoder, the order of transforms is reversed. Further, in JEM, whether a secondary transform is applied to generate transform coefficients may be dependent on a prediction mode.

A quantization process may be performed on transform coefficients. Quantization scales transform coefficients in order to vary the amount of data required to send a group of transform coefficients. Quantization may include division of transform coefficients by a quantization scaling factor and any associated rounding functions (e.g., rounding to the nearest integer). Quantized transform coefficients may be referred to as coefficient level values or simply level values. Inverse quantization (or “dequantization”) may include multiplication of coefficient level values by the quantization scaling factor. It should be noted that, as used herein, the term quantization process in some instances may refer to division by a quantization scaling factor to generate level values and multiplication by a quantization scaling factor to recover transform coefficients in some instances. That is, a quantization process may refer to quantization in some cases and inverse quantization in some cases. In ITU-T H.265, the value of a quantization scaling factor (referred to as Qₛₜₑₚ in ITU-T H.265) may be determined by a quantization parameter (QP). It should be noted that as used herein the term quantization parameter may be used to refer generally to a parameter used to determining values for quantization (e.g., quantization scaling factors) and/or may be used to more specifically refer to a specific implementation of a quantization parameter (e.g., Qp′_{Y} in ITU-T H.265). In ITU-T H.265, the quantization parameter can take 52 values from 0 to 51 and a change of 1 for the quantization parameter generally corresponds to a change in the value of the Qₛₜₑₚ by approximately 12%.

Quantized transform coefficients and related data may be entropy coded according to an entropy encoding technique (e.g., content adaptive variable length coding (CAVLC), context adaptive binary arithmetic coding (CABAC), probability interval partitioning entropy coding (PIPE), etc.). Further, syntax elements, such as, a syntax element indicating a prediction mode, may also be entropy coded. Entropy encoded quantized transform coefficients and corresponding entropy encoded syntax elements may form a compliant bitstream that can be used to reproduce video data. A binarization process may be performed on syntax elements as part of an entropy coding process. Binarization refers to the process of converting a syntax value into a series of one or more bits. These bits may be referred to as “bins.” Binarization is a lossless process and may include one or a combination of the following coding techniques: fixed length coding, unary coding, truncated unary coding, truncated Rice coding, Golomb coding, k-th order exponential Golomb coding, and Golomb-Rice coding. As used herein each of the terms fixed length coding, unary coding, truncated unary coding, truncated Rice coding, Golomb coding, k-th order exponential Golomb coding, and Golomb-Rice coding may refer to general implementations of these techniques and/or more specific implementations of these coding techniques. For example, a Golomb-Rice coding implementation may be specifically defined according to a video coding standard, for example, ITU-T H.265. After binarization, a CABAC entropy encoder may select a context model. For a particular bin, a context model may be selected from a set of available context models associated with the bin. In some examples, a context model may be selected based on a previous bin and/or values of previous syntax elements. For example, a context model may be selected based on the value of a neighboring intra prediction mode. A context model may identify the probability of a bin being a particular value. For instance, a context model may indicate a 0.7 probability of coding a 0-valued bin and a 0.3 probability of coding a 1-valued bin. After selecting an available context model, a CABAC entropy encoder may arithmetically code a bin based on the identified context model. It should be noted that some syntax elements may be entropy encoded using arithmetic encoding without the usage of an explicitly assigned context model, such coding may be referred to as bypass coding.

As described above, residual data may include the difference between sample values included in a current CU, or the like, (e.g., a CB in JEM) and associated reference samples those generated using a prediction. As described above, examples of prediction techniques include intra and inter prediction techniques. Intra prediction techniques generally refer to techniques where a predictive block of video data is generated from sample values within a current picture (or frame) of video, where, e.g., a directional prediction mode may be used to signal how the predictive video block of video data is generated. Inter prediction techniques generally refer to techniques where a predictive block of video data is generated from sample values included in one or more reference pictures. For example, a motion vector may be used to indicate the displacement of a predictive block within a reference picture relative to a CB, PB, CU, or the like.

One example of inter prediction includes so-called affine motion compensation prediction. An example of an affine motion compensation prediction implementation is described in S. Lin, H. Chen, H. Zhang, S. Maxim, H. Yang, J. Zhou, “Affine transform prediction for next generation video coding,” ITU-T SG16 Doc. COM16-C1016, October 2015, which is incorporated by reference in its entirety. JEM supports an implementation of affine motion compensation prediction. The techniques described herein may be generally applicable to affine motion compensation prediction implementations. Affine motion compensation prediction techniques may be particularly useful for coding a video sequence including rotational motion (as opposed to translation motion). For a current CB, or the like, of video data, affine motion prediction techniques determine one or more control motion vectors. JEM provides two modes for determining control motion vectors, a AF_INTER mode and a AF_MERGE mode. In the AF_INTER mode, control motion vectors are determined (and signaled) based on a candidate list of motion vectors, where the candidate list of motion vectors may include motion vectors of neighboring blocks of video data. In this manner, a control motion vector may be signaled as a difference with respect to a motion vector included in a candidate list of motion vectors. In the AF_MERGE mode, a control motion vector may be inherited from a neighboring block of video data. In an example neighboring block of video data may be within the same picture as the block of video data being coded. In an example neighboring block of video data may be within a picture coded in the past. It should be noted the techniques described herein may be generally applicable to various techniques of determining the control motion vectors.

In affine motion compensation prediction techniques, based on the control motion vectors, so-called motion vector fields (MVFs) may be determined for sub-blocks within the CB. JEM provides where the motion vector fields are generated based on the following equations:

$$\{ \begin{matrix}{v}_{x} = \frac{( {v}_{1 x} - {v}_{0 x} )}{w} x - \frac{( {v}_{1 y} - {v}_{0 y} )}{w} y + {v}_{0 x} \\ {v}_{y} = \frac{( {v}_{1 y} - {v}_{0 y} )}{w} x + \frac{( {v}_{1 x} - {v}_{0 x} )}{w} y + {v}_{0 y}\end{matrix} \qquad ( MVF\_ 1 )$$

where,

(v₀ₓ, v_{0y}) is the motion vector of the top-left corner control point (i.e., control motion vector v₀),

(v₁ₓ, v_{1y}) is the motion vector of the top-right corner control point (i.e., control motion vector v₁),

w is the width of a CB, and

(x, y) is the location of a respective sample within a current CB. In another example (x, y) is a representative location such as top-left corner, top-right corner, center, bottom-left corner, bottom-right corner of sub-block under consideration.

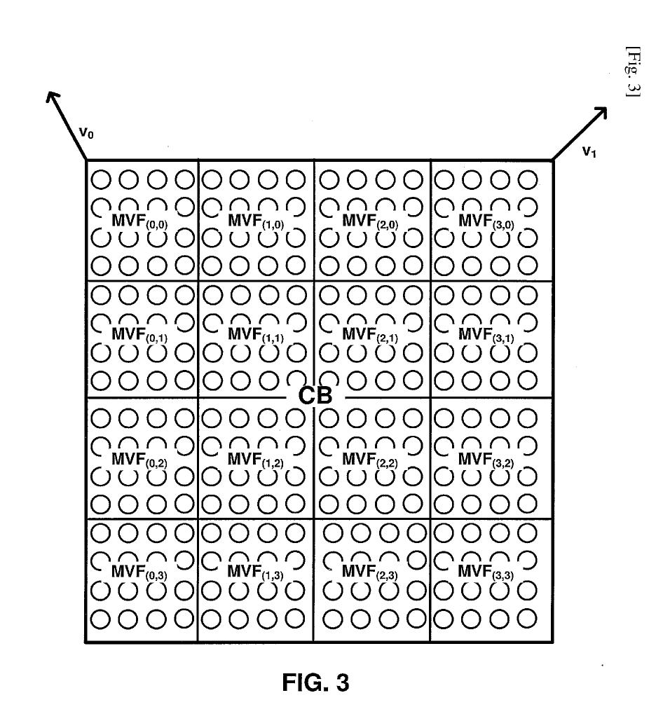

FIG. 3 is a conceptual diagram illustrating an example of deriving motion vector fields in accordance with one or more techniques of this disclosure. In the example illustrated in FIG. 3, for a 16×16 CB of video data, for each 4×4 sub-block, respective motion vector fields (i.e., MVF_{(x-y)}) are generated based on control motion vectors, v₀ and v₁. It should be noted that in the JEM implementation of affine motion compensation prediction, the size of sub-blocks that are used for performing motion compensation (and, thus the number of MVFs for a CB) may be determined as a function of a top-left corner control point, a top-right corner control point, and a bottom left corner control point (i.e., v₀, v₁, and v₂). For example, JEM provides where a sub-block used for motion compensation may be larger than 4×4 (e.g., 8×8). In particular, in the JEM implementation of affine motion compensation, the following process is utilized: v₀ and v₁ are obtained (i.e., using AF_INTER or AF_MERGE); v₀ and v₁ are used to calculate a set of initial MVFs for each 4×4 sub-block and further calculate a bottom left corner control point (v₂) and a bottom right control point (v₃); the initially calculated MVFs for the 4×4 sub-blocks located at the corners of the CB are overwritten with respective collocational control points (i.e., v₀, v₁, v₂, and v₃ are stored by overwriting the values of the respective MVFs for the 4×4 sub-blocks located at the top-left corner, top-right corner, bottom-left corner, and bottom right-corner); the size of the CB and difference between v₀, v₁, and v₂ are used to determine the size of sub-blocks that will be used to perform motion compensation; and the MVFs are recalculated based on the size of sub-blocks that will be used to perform motion compensation. In the JEM implementation of affine motion compensation prediction, each of the recalculated MVFs are used to perform motion compensation, i.e., generate a predictive block of video data for each sub-block.

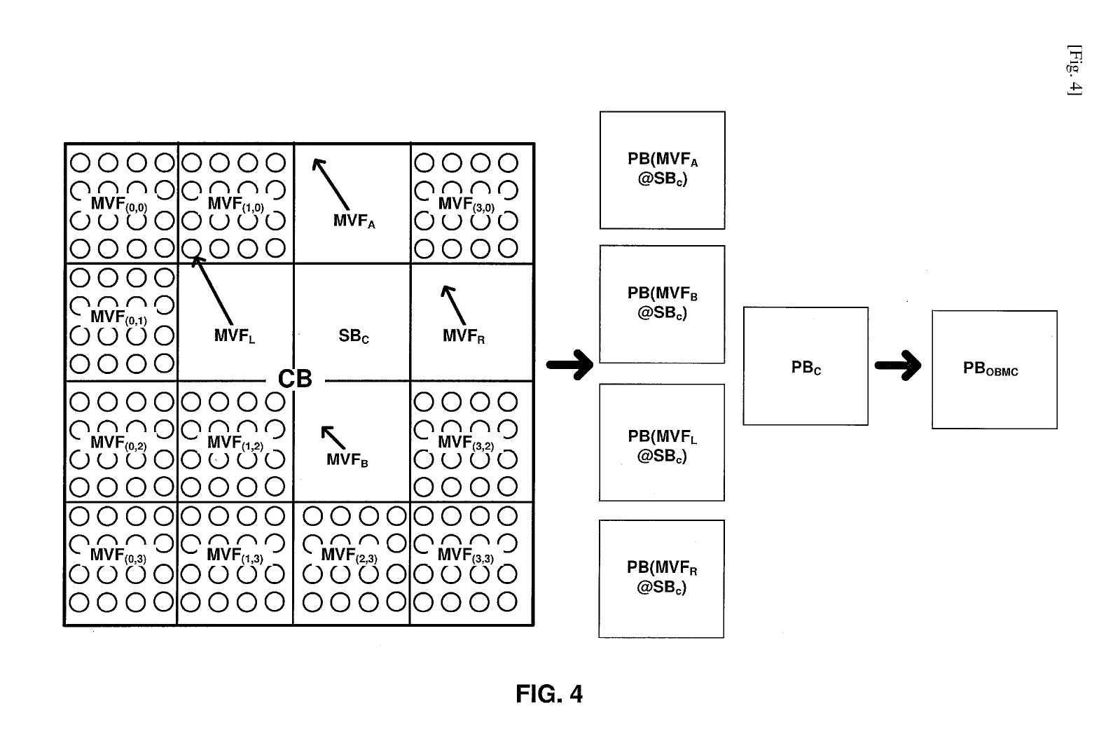

Further, JEM supports an implementation of overlapped block motion compensation (OBMC). Overlapped block motion compensation techniques may generally refer to techniques where for a current block of video data, a final predictive block of video data is generated as a weighted sum of intermediate predictive blocks of video data, where each intermediate predictive block of video data is generated using a respective motion vector. In JEM, the OBMC implementation is based on 4×4 sub-blocks. For sub-blocks located at the top and left boundaries of a CB, motions vectors of neighboring sub-blocks (i.e., left and/or above sub-blocks located in neighboring CBs) are used to generate intermediate predictive blocks of video data. For sub-blocks located in the interior a CB (i.e., sub-blocks having a above, below, left, and right neighbors in a current CB), motions vectors of neighboring sub-blocks are used to generate intermediate predictive blocks of video data. The intermediate predictive block generated from the motion vectors of the neighboring sub-blocks are weighed with the intermediate predictive block generated from the motion vector of the current sub-block to generate a final predictive block. FIG. 4 illustrates an example where for a current sub-block, SB_{C}, a final predictive block, PB_{OBMC}, is generated as the weighted sum of the intermediate predictive block generated from the motion vector of the current sub-block, PB_{C}, and the intermediate predictive blocks generated from the motion vectors of the above, below, left, and right neighboring sub-blocks (i.e., PB(MVF_{A}@SB_{C}), PB(MVF_{B}@SB_{C}), PB(MVF_{L}@SB_{C}), and PB(MVF_{R}@SB_{C})). It should be noted that in FIG. 4, the “@SB_{C}” notation refers to the location of the current sub-block (i.e., the neighboring motion vector is applied at the sample location of the current sub-block).

It should be noted that in JEM, the OBMC process used to generate the final predictive block is performed subsequent to performing the affine motion compensation implementation. That is, in JEM, the intermediate predictive block from the motion vector of the current sub-block, PB_{C}, corresponds to the predictive block or a 4×4 sub-block within the predictive block, generated at the affine motion compensation stage, and further the intermediate predictive blocks generated from the motion vectors of the above, below, left, and right neighboring sub-blocks are generated subsequent to the affine motion compensation stage. Performing affine motion compensation prediction and OBMC in this manner may be less than ideal. For example, in some cases, performing OBMC in this manner may result in poor performance.

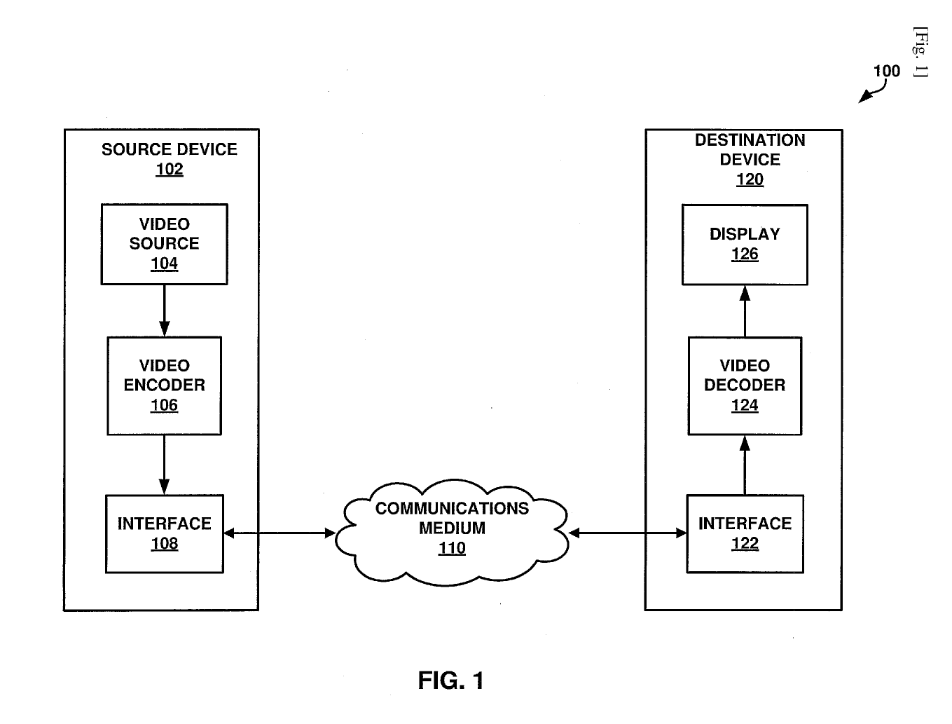

FIG. 1 is a block diagram illustrating an example of a system that may be configured to code (i.e., encode and/or decode) video data according to one or more techniques of this disclosure. System 100 represents an example of a system that may reconstruct video data according to one or more techniques of this disclosure. As illustrated in FIG. 1, system 100 includes source device 102, communications medium 110, and destination device 120. In the example illustrated in FIG. 1, source device 102 may include any device configured to encode video data and transmit encoded video data to communications medium 110. Destination device 120 may include any device configured to receive encoded video data via communications medium 110 and to decode encoded video data. Source device 102 and/or destination device 120 may include computing devices equipped for wired and/or wireless communications and may include set top boxes, digital video recorders, televisions, desktop, laptop, or tablet computers, gaming consoles, mobile devices, including, for example, “smart” phones, cellular telephones, personal gaming devices, and medical imagining devices.

Communications medium 110 may include any combination of wireless and wired communication media, and/or storage devices. Communications medium 110 may include coaxial cables, fiber optic cables, twisted pair cables, wireless transmitters and receivers, routers, switches, repeaters, base stations, or any other equipment that may be useful to facilitate communications between various devices and sites. Communications medium 110 may include one or more networks. For example, communications medium 110 may include a network configured to enable access to the World Wide Web, for example, the Internet. A network may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and Institute of Electrical and Electronics Engineers (IEEE) standards.

Storage devices may include any type of device or storage medium capable of storing data. A storage medium may include a tangible or non-transitory computer-readable media. A computer readable medium may include optical discs, flash memory, magnetic memory, or any other suitable digital storage media. In some examples, a memory device or portions thereof may be described as non-volatile memory and in other examples portions of memory devices may be described as volatile memory. Examples of volatile memories may include random access memories (RAM), dynamic random access memories (DRAM), and static random access memories (SRAM). Examples of non-volatile memories may include magnetic hard discs, optical discs, floppy discs, flash memories, or forms of electrically programmable memories (EPROM) or electrically erasable and programmable (EEPROM) memories. Storage device(s) may include memory cards (e.g., a Secure Digital (SD) memory card), internal/external hard disk drives, and/or internal/external solid state drives. Data may be stored on a storage device according to a defined file format.

Referring again to FIG. 1, source device 102 includes video source 104, video encoder 106, and interface 108. Video source 104 may include any device configured to capture and/or store video data. For example, video source 104 may include a video camera and a storage device operably coupled thereto. Video encoder 106 may include any device configured to receive video data and generate a compliant bitstream representing the video data. A compliant bitstream may refer to a bitstream that a video decoder can receive and reproduce video data therefrom. Aspects of a compliant bitstream may be defined according to a video coding standard. When generating a compliant bitstream, video encoder 106 may compress video data. Compression may be lossy (discernible or indiscernible) or lossless. Interface 108 may include any device configured to receive a compliant video bitstream and transmit and/or store the compliant video bitstream to a communications medium. Interface 108 may include a network interface card, such as an Ethernet card, and may include an optical transceiver, a radio frequency transceiver, or any other type of device that can send and/or receive information. Further, interface 108 may include a computer system interface that may enable a compliant video bitstream to be stored on a storage device. For example, interface 108 may include a chipset supporting Peripheral Component Interconnect (PCI) and Peripheral Component Interconnect Express (PCIe) bus protocols, proprietary bus protocols, Universal Serial Bus (USB) protocols, I²C, or any other logical and physical structure that may be used to interconnect peer devices.

Referring again to FIG. 1, destination device 120 includes interface 122, video decoder 124, and display 126. Interface 122 may include any device configured to receive a compliant video bitstream from a communications medium. Interface 108 may include a network interface card, such as an Ethernet card, and may include an optical transceiver, a radio frequency transceiver, or any other type of device that can receive and/or send information. Further, interface 122 may include a computer system interface enabling a compliant video bitstream to be retrieved from a storage device. For example, interface 122 may include a chipset supporting PCI and PCIe bus protocols, proprietary bus protocols, USB protocols, I²C, or any other logical and physical structure that may be used to interconnect peer devices. Video decoder 124 may include any device configured to receive a compliant bitstream and/or acceptable variations thereof and reproduce video data therefrom. Display 126 may include any device configured to display video data. Display 126 may comprise one of a variety of display devices such as a liquid crystal display (LCD), a plasma display, an organic light emitting diode (OLED) display, or another type of display. Display 126 may include a High Definition display or an Ultra High Definition display. It should be noted that although in the example illustrated in FIG. 1, video decoder 124 is described as outputting data to display 126, video decoder 124 may be configured to output video data to various types of devices and/or sub-components thereof. For example, video decoder 124 may be configured to output video data to any communication medium, as described herein.

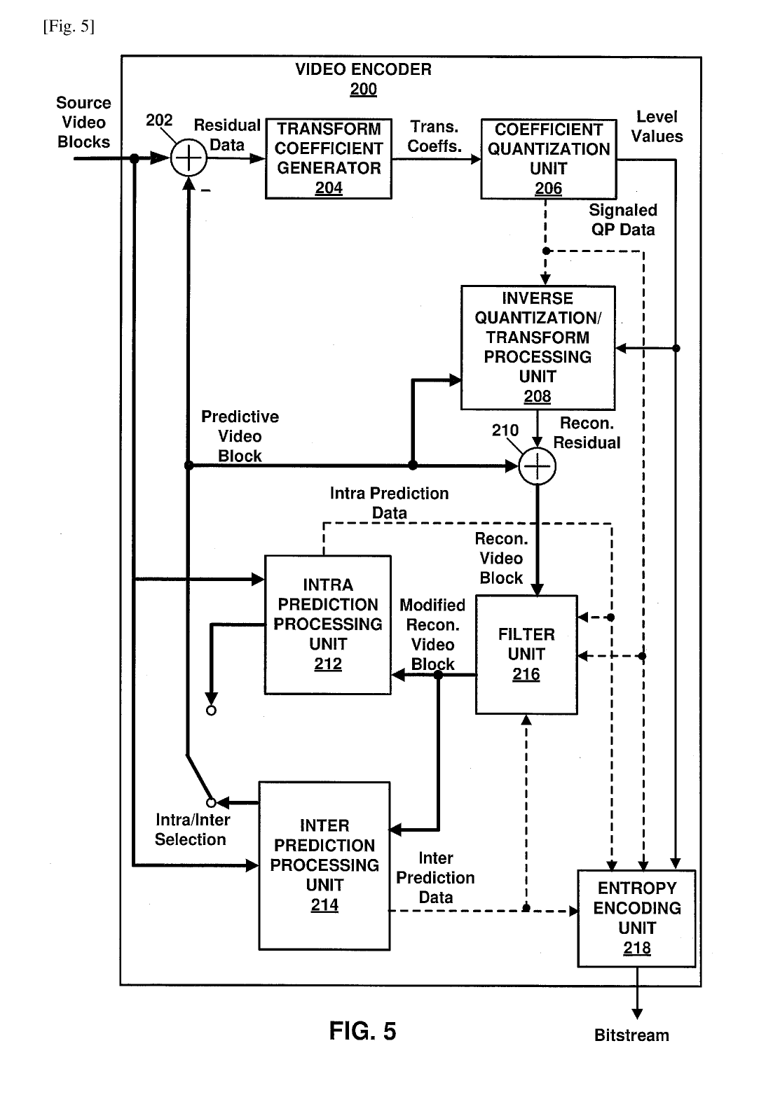

FIG. 5 is a block diagram illustrating an example of video encoder 200 that may implement the techniques for encoding video data described herein. It should be noted that although example video encoder 200 is illustrated as having distinct functional blocks, such an illustration is for descriptive purposes and does not limit video encoder 200 and/or sub-components thereof to a particular hardware or software architecture. Functions of video encoder 200 may be realized using any combination of hardware, firmware, and/or software implementations. In one example, video encoder 200 may be configured to encode video data according to the techniques described herein. Video encoder 200 may perform intra prediction coding and inter prediction coding of picture areas, and, as such, may be referred to as a hybrid video encoder. In the example illustrated in FIG. 5, video encoder 200 receives source video blocks. In some examples, source video blocks may include areas of picture that has been divided according to a coding structure. For example, source video data may include macroblocks, CTUs, CBs, sub-divisions thereof, and/or another equivalent coding unit. In some examples, video encoder may be configured to perform additional sub-divisions of source video blocks. It should be noted that the techniques described herein are generally applicable to video coding, regardless of how source video data is partitioned prior to and/or during encoding. In the example illustrated in FIG. 5, video encoder 200 includes summer 202, transform coefficient generator 204, coefficient quantization unit 206, inverse quantization/transform processing unit 208, summer 210, intra prediction processing unit 212, inter prediction processing unit 214, filter unit 216, and entropy encoding unit 218. As illustrated in FIG. 5, video encoder 200 receives source video blocks and outputs a bitstream.

In the example illustrated in FIG. 5, video encoder 200 may generate residual data by subtracting a predictive video block from a source video block. Summer 202 represents a component configured to perform this subtraction operation. In one example, the subtraction of video blocks occurs in the pixel domain. Transform coefficient generator 204 applies a transform, such as a discrete cosine transform (DCT), a discrete sine transform (DST), or a conceptually similar transform, to the residual block or sub-divisions thereof (e.g., four 8×8 transforms may be applied to a 16×16 array of residual values) to produce a set of residual transform coefficients. Transform coefficient generator 204 may be configured to perform any and all combinations of the transforms included in the family of discrete trigonometric transforms. Transform coefficient generator 204 may output transform coefficients to coefficient quantization unit 206.

Coefficient quantization unit 206 may be configured to perform quantization of the transform coefficients. As described above, the degree of quantization may be modified by adjusting a quantization scaling factor which may be determined by quantization parameters. Coefficient quantization unit 206 may be further configured to determine quantization values and output QP data that may be used by a video decoder to reconstruct a quantization parameter (and thus a quantization scaling factor) to perform inverse quantization during video decoding. For example, signaled QP data may include QP delta values. In ITU-T H.265, the degree of quantization applied to a set of transform coefficients may depend on slice level parameters, parameters inherited from a previous coding unit, and/or optionally signaled CU level delta values.

As illustrated in FIG. 5, quantized transform coefficients are output to inverse quantization/transform processing unit 208. Inverse quantization/transform processing unit 208 may be configured to apply an inverse quantization and/or an inverse transformation to generate reconstructed residual data. As illustrated in FIG. 5, at summer 210, reconstructed residual data may be added to a predictive video block. In this manner, an encoded video block may be reconstructed and the resulting reconstructed video block may be used to evaluate the encoding quality for a given quality for a given prediction, transformation type, and/or level of quantization. Video encoder 200 may be configured to perform multiple coding passes (e.g., perform encoding while varying one or more coding parameters). The rate-distortion of a bitstream or other system parameters may be optimized based on evaluation of reconstructed video blocks. Further, reconstructed video blocks may be stored and used as reference for predicting subsequent blocks.

As described above, a video block may be coded using an intra prediction. Intra prediction processing unit 212 may be configured to select an intra prediction mode for a video block to be coded. Intra prediction processing unit 212 may be configured to evaluate a frame and/or an area thereof and determine an intra prediction mode to use to encode a current block. As illustrated in FIG. 5, intra prediction processing unit 212 outputs intra prediction data (e.g., syntax elements) to filter unit 216 and entropy encoding unit 218. In ITU-T H.265, defined possible intra prediction modes include a planar (i.e., surface fitting) prediction mode (predMode: 0), a DC (i.e., flat overall averaging) prediction mode (predMode: 1), and 33 angular prediction modes (predMode: 2-34). In JEM, defined possible intra-prediction modes include a planar prediction mode (predMode: 0), a DC prediction mode (predMode: 1), and 65 angular prediction modes (predMode: 2-66). It should be noted that planar and DC prediction modes may be referred to as non-directional prediction modes and that angular prediction modes may be referred to as directional prediction modes. It should be noted that the techniques described herein may be generally applicable regardless of the number of defined possible prediction modes. Further, in some examples, a prediction for a chroma component may be inferred from an intra prediction for a luma prediction mode.

Inter prediction processing unit 214 may be configured to perform inter prediction coding for a current video block. Inter prediction processing unit 214 may be configured to generate a predictive block using the motion prediction data. For example, inter prediction processing unit 214 may locate a predictive video block within a frame buffer (not shown in FIG. 5). Inter prediction processing unit 214 may output motion prediction data for a calculated motion vector to filter unit 216 and entropy encoding unit 218. Inter prediction processing unit 214 may be configured to receive source video blocks and calculate a motion vector for PUs, or the like, of a video block. A motion vector may indicate the displacement of a PU, or the like, of a video block within a current video frame relative to a predictive block within a reference frame. Inter prediction coding may use one or more reference pictures. Further, motion prediction may be uni-predictive (use one motion vector) or bipredictive (use two motion vectors). Inter prediction processing unit 214 may be configured to select a predictive block by calculating a pixel difference determined by, for example, sum of absolute difference (SAD), sum of square difference (SSD), or other difference metrics. A motion vector and associated data may describe, for example, a horizontal component of the motion vector, a vertical component of the motion vector, a resolution for the motion vector (e.g., one-quarter pixel precision), a prediction direction and/or a reference picture index value. Further, a coding standard, such as, for example ITU-T H.265, may support motion vector prediction. Motion vector prediction enables a motion vector to be specified using motion vectors of neighboring blocks. Examples of motion vector prediction include advanced motion vector prediction (AMVP), temporal motion vector prediction (TMVP), so-called “merge” mode, and “skip” and “direct” motion inference. Further, JEM supports advanced temporal motion vector prediction (ATMVP), spatial-temporal motion vector prediction (STMVP), and advanced motion vector resolution (AMVR) mode. It should be noted that inter prediction processing unit 214 may further be configured to apply one or more interpolation filters to calculate sub-integer pixel values for use in motion estimation.

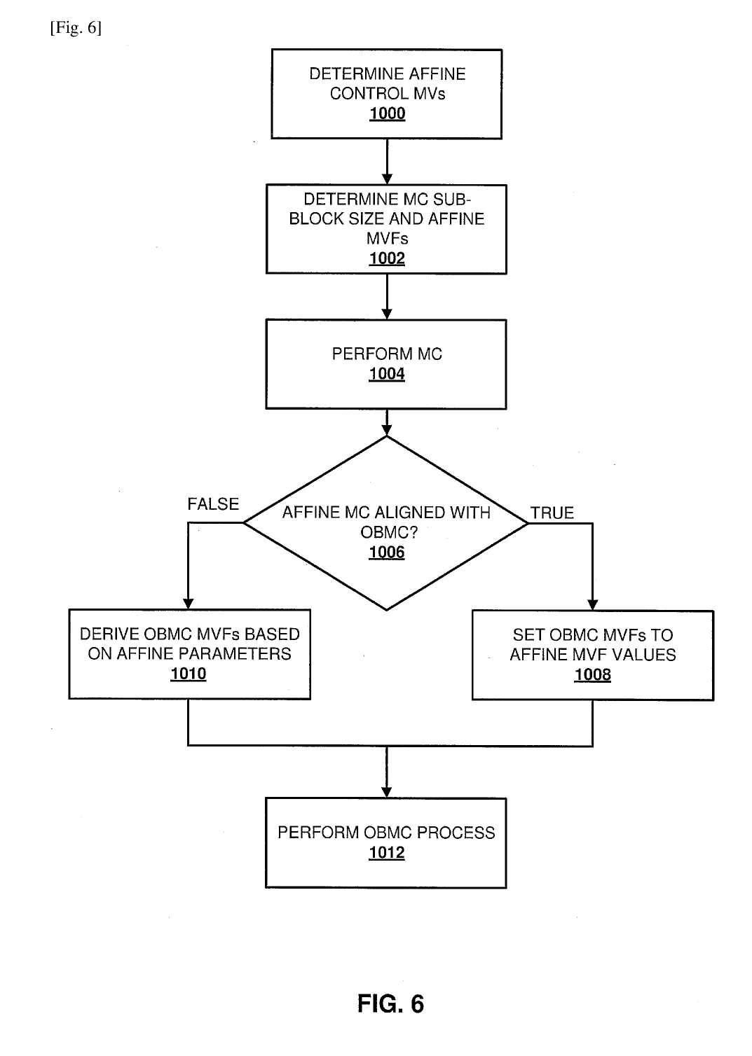

Further, as described above, JEM supports an affine motion compensation prediction and OBMC implementation. Inter prediction processing unit 214 may be configured to perform inter prediction coding according to the techniques described in JEM. Further, inter prediction processing unit 214 may be configured to perform inter prediction coding according to one or more of the techniques described herein. For example, inter prediction processing unit 214 may be configured to perform inter prediction coding in accordance with one or more of the techniques illustrated with respect to FIGS. 6-9. The examples illustrated in FIGS. 6-9 generally illustrate examples of affine motion compensation prediction techniques, OBMC techniques, and combinations thereof. It should be noted that although the techniques illustrated with respect to FIGS. 6-9 are described with respect to inter prediction processing unit 214 the techniques described may be realized in a system using any combination of hardware, firmware, and/or software implementations. Further, it should be noted that with respect to the flowcharts described herein, inter prediction processing unit 214 may be configured to perform less than all of the illustrated decisions and resulting outcomes and/or perform the illustrated decisions and resulting outcomes may be performed in various sequences.

Referring to FIG. 6, for a CB of video data, or the like, inter prediction processing unit 214 determines affine control motion vectors (1000). In one example, inter prediction processing unit 214 may determine affine control motion vectors according to the techniques provided in JEM. For example, inter prediction processing unit 214 may be configured to determine control motion vector using an AF_INTER mode and an AF_MERGE mode. It should be noted that in some examples, inter prediction processing unit 214 may be configured to determine control motion vectors using a combination and/or variations of an AF_INTER mode and an AF_MERGE mode. For example, inter prediction processing unit 214 may be configured to determine a top-left and a top-right motion control vector (e.g., v₀ and v₁) using an AF_INTER mode and determine a bottom-left and a bottom-right control motion vectors (e.g., v₂ and v₃) using an AF_MERGE mode.

At 1002, for the CB of video data, inter prediction processing unit 214 determines the size of sub-blocks to be used for affine motion compensation and the corresponding MVFs. As described above, the QTBT structure in JEM supports square CB having the following sizes: 256×256, 128×128, 64×64, 32×32, 16×16, 8×8, and 4×4, and further supports binary splitting of square CBs. In one example, inter prediction processing unit 214 may be configured to determine the size of the sub-blocks to be used for the affine motion compensation based on the size and/or shape of a CB. For example, for a CB having a height or width greater than or equal to 128, inter prediction processing unit 214 may determine that the size of the sub-blocks to be used for the affine motion compensation is 16×16 and for a CB having a height and width less than 128, inter prediction processing unit 214 may determine that the size of the sub-blocks to be used for the affine motion compensation is 8×8.

Further, in some examples, additional or alternatively, inter prediction processing unit 214 may be configured to determine the size of the sub-blocks to be used for the affine motion compensation based on the values of control motion vectors. For example, in one example, inter prediction unit 214 may be configured to determine a maximum size and/or a minimum size based on the height and/or width of a CB and determine the actual size of the sub-blocks to be used for the affine motion compensation based on control motion vectors. For example, for a CB having a height or width greater than or equal to 128, inter prediction processing unit 214 may determine that the maximum size of the sub-blocks that may be used for the affine motion compensation is 32×32 and that the minimum size of the sub-blocks that may be used for the affine motion compensation is 8×8. An indication for the sub-block size to be used may be signaled/inferred for a CB. Further, for a CB having a height and width less than 128, inter prediction processing unit 214 may determine that the maximum size of the sub-blocks to be used for the affine motion compensation is 16×16 and that the minimum size of the sub-blocks that may be used for the affine motion compensation is 4×4. Further, once a maximum and a minimum size are determined, inter prediction processing unit 214 may determine the size of the sub-blocks to be used for the affine motion compensation based on control motion vectors. For example, in an example where sub-blocks have a square shape, a sub-block size may be selected from available square sizes within an inclusive range of specified by the minimum size and the maximum size. In one example, available square sizes may include the following sizes: 256×256, 128×128, 64×64, 32×32, 16×16, 8×8, and 4×4. In another example, a sub-block size may be non-square sizes within an inclusive range of specified by the minimum size and the maximum size. In one example, available widths and/or heights may include 256, 128, 64, 32, 16, 8, and 4. In one example, for a 256×256 CB, available sub-block sizes may include 64×64, 64×16, 32×32, 16×16, and 8×8. In one example, for a 128×128 CB, available sub-block sizes may include 64×64, 32×32, 32×16, 16×16, 8×8 and 4×4. In one example, a range of sizes of sub-blocks that may be used for the affine motion compensation is signaled in the bitstream, for example, in parameter sets (e.g., sequence parameter set, picture parameter set). In an example, non-square sub-blocks may be used for motion compensation. In an example, non-square sub-blocks may be used for non-square CBs. In an example, when bi-prediction is used for a CB, the sub-block sizes for each prediction may be different.

In one example, once a maximum and a minimum size are determined based on a CB size, inter prediction processing unit 214 may determine the size of the sub-blocks to be used for the affine motion compensation based on control motion vectors based on the horizontal component length and/or vertical component length of one or more control motion vectors. For example, in the case where (v₀ₓ, v_{0y}) is the motion vector of the top-left corner control point, (v₁ₓ, v_{1y}) is the motion vector of the top-right corner control point, and (v₂ₓ, v_{2y}) is the motion vector of the bottom-left corner control point, inter prediction processing unit 214 may determine the following values:

Diff₁=max(Abs(v₁ₓ−v₀ₓ),Abs(v_{1y}−v_{0y})); and

Diff₂=max(Abs(v₂ₓ−v₀ₓ),Abs(v_{2y}−v_{0y}));
where Abs(x) is the absolute value of x, and
   Max(x,y) returns x, if x>y, else y,

Diff₁ and Diff₂ provide indications of the degree of variation between respective control motion vectors. Diff₁ provides indications of the degree of variation between motion vector of top-left control point and motion vector of top-right control point. Diff₁ is also related to the size of width of sub-block, i.e., the larger Diff₁ the smaller width of sub-block. Diff₂ provides indications of the degree of variation between motion vector of top-left control point and motion vector of left-bottom control point. Diff₂ is also related to the size of height of sub-block, i.e., the larger Diff₂ the smaller height of sub-block. In general, for a relatively large degree of variation between respective control motion vectors, it is desirable to use relatively smaller sub-blocks for motion compensation in order to improve the quality of predictions. Thus, for relative high values of Diff₁ and Diff₂ inter prediction processing unit 214 may select a relatively small available sub-block size. Further, the relationship between the values of Diff₁ and Diff₂ and a selected sub-block may be further based on a CB size. For example, ratios of Diff₁ and Diff₂ and a CB size may be used to determine a selected CB size.

In one example, once inter prediction processing unit 214 determines the size of sub-blocks to be used for affine motion compensation, inter prediction processing unit 214 calculates the corresponding MVFs for each sub-block. In one example, for sub-blocks having a 4×4 size, inter prediction processing unit 214 may be configured to calculate the MVFs according to the equations (MVF_1) provided above. It should be noted that in other examples, inter prediction processing unit 214 may be configured to calculate MVFs based on fewer (e.g., 1) or more (e.g., 3, or 4) control motion vectors.

In one example, for sub-blocks having a size larger than 4×4, inter prediction processing unit 214 may be configured to calculate the MVFs used for motion compensation based on MVFs corresponding to 4×4 sub-blocks. For example, for a CB having a size defined as Width_{CB}×Height_{CB} including W×H sub-blocks, inter prediction processing unit 214 may determine the MVF for each 4×4 sub-block within the CB (e.g., based on (MVF_1) or using three motion control vectors).

In one example, inter prediction processing unit 214 may determine a center point for each W×H sub-block. In one example, a center point (x_{c}, y_{c}) may be determined as:

x_{c}=x_{right}−W/2+C1

y_{c}=y_{bottom}−H/2+C2
where,
x_{right} is the right most column of the sub-block,
y_{bottom} is the bottom most row of the sub-block,
and C1 and C2 are predetermined values.

Further, inter prediction processing unit 214 may determine a duplication factor by dividing a sub-block height and width by a factor (e.g., 2, 4, 8, etc.). For example, inter prediction processing unit 214 may determine a duplication factor as follows:

DF_{H}=W/4

DF_{Y}=H/4

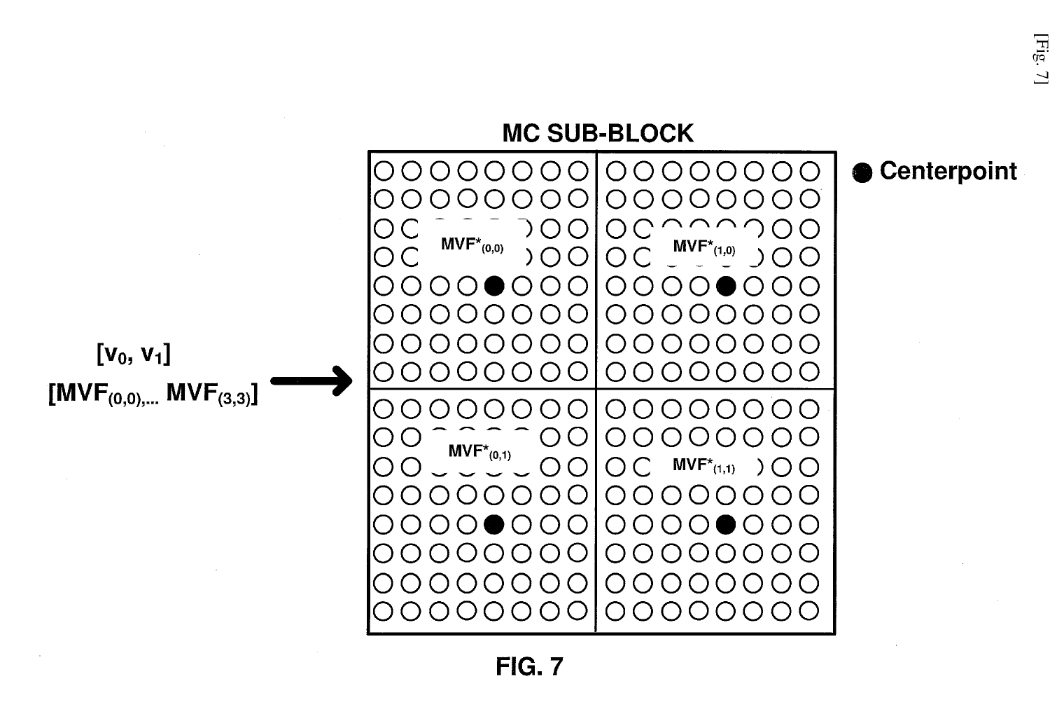

Finally, inter prediction processing unit 214 may determine a MVF for the motion compensation sub-block by duplicating the MVF calculated the center point. Here, in order to keep up with OBMC process where 4×4 sub-block MVF is considered, the MVF calculated at the center point is repeated (duplicated) in 4×4 sub-block unit within the motion compensation sub-block based on the duplication factors. In other words, the given motion compensation block is divided into 4×4 sub-blocks and the MVF calculated at the center point may be used for the sub-block MVFs. Note that sub-blocks within the motion compensation block will have the same MVF which is the MVF calculated at the center point. For example, duplicating may include setting MVF values at reference points within the motion compensation sub-block, where the number of reference points is determined by the duplication factor. FIG. 7 is a conceptual diagram illustrating an example of determining MVFs for 8×8 sub-blocks of a 16×16 CB. It should be noted that the example illustrated in FIG. 7 corresponds to the example illustrated in FIG. 3, where for a 16×16 CB of video data, for each 4×4 sub-block, respective motion vector fields (i.e., MVF_{(x,y)}) are generated based on control motion vectors, v₀ and v₁. It should be noted that in other examples, for each 4×4 sub-block, respective motion vector fields (i.e., MVF_{(x,y)}) may be generated based on more than two control motion vectors.

As described above, in the JEM implementation of affine motion compensation, the size of the CB and difference between v₀, v₁, and v₂ are used to determine the size of sub-blocks that will be used to perform motion compensation and the MVFs are recalculated based on the size of sub-blocks that will be used to perform motion compensation. Determining the size of sub-blocks in this manner may be less than ideal. In one example, according to the techniques of this disclosure, inter prediction unit 214 may be configured to determine the size of sub-blocks that will be used to perform motion compensation based on a predetermined value. For example, in one example the size of the sub-blocks that will be used for motion compensation may fixed at the sequence level, the picture level, the slice level, the CTU level, and/or the CU level. For example, for a first slice of video data, the sub-block size that will be used for motion compensation may be fixed as 4×4 and for a second slice of video data the sub-block size that will be used for motion compensation may be fixed as 8×8. Further, in one example, according to the techniques of this disclosure, inter prediction unit 214 may be configured to determine the size of sub-blocks that will be used to perform motion compensation based on a predetermined value and the size of a current CB (or CU). For example, in one example, the size of the sub-blocks that will be used for motion compensation may be based on the size of a current CB and a predetermined value that is fixed at the sequence level, the picture level, the slice level, the CTU level and/or the CU level. For example, predetermined values N_{W} and N_{H} may be respectively divided by the width and height of the current CB to determine the size of sub-blocks that are used for motion compensation. For example, if the size of a current CB is 16×16 and N_{W} and N_{H} are set equal to 4 for a slice of video data, the size of the size of sub-blocks that are used for motion compensation for the current CB is 4×4. Likewise, if the size of a current CB size is 32×32 and N_{W} and N_{H} are set equal to 4 for a slice of video data, the size of the size of sub-blocks that are used for motion compensation for the current CB is 8×8. It should be noted that in some examples hierarchical signaling may be used to indicate a predetermined value used to indicate the size of sub-blocks used for motion compensation. For example, in one example, available sizes of sub-blocks used for motion compensation (e.g., 16×16, 8×8, and 4×4) may be indicated at a picture level and one of the available sizes of sub-blocks may be signaled for each slice within the picture (e.g., 8×8 for a first slice and 4×4 for a second slice). In other examples, other types of hierarchical signaling may be used. For example, any of sequence level signaling, picture level signaling, slice level signaling, and/or CTU level signaling may indicate available sub-block sizes and any of picture level signaling, slice level signaling, CTU level signaling and/or CU level signaling may indicate the sub-block size used for a CB (or CU). In this manner, compared to the JEM implementation of affine motion compensation, the size of sub-blocks that will be used to perform motion compensation may be determined while performing fewer calculations (e.g., without performing additional calculations based on v₀, v₁, and v₂).

In one example, according to the techniques of this disclosure, inter prediction unit 214 may be configured to determine the size of sub-blocks that will be used to perform motion compensation based on a predetermined value and determine how MVF values are derived based on the size of a current CB (or CU) and/or based on the values of control points. For example, in one example, the size of sub-blocks that are used for motion compensation may be fixed as 4×4 for a slice of video data, as described above, and equations used for generating motion vector fields may be based on the size of a current CB (or CU) and/or based on the values of control points. For example, referring to the equations MVF_1 provided above with respect to JEM, in one example, the variable w in the equations may be replaced with a function dependent on the size of a current CB (or CU) and/or the values of control points. For example, in one example w may be a function of Diff₁ and/or Diff₂ described above. In an example (x,y) in MVF_1 may be determined based on size of current CB. In an example (x, y) in MVF_1 may be determined based on distance from control motion vector points.

As described above, in the JEM implementation of affine motion compensation, the initially calculated MVFs for the 4×4 sub-blocks located at the corners of the CB are overwritten with respective collocational control points (i.e., v₀, v₁, v₂, and v₃). Overwriting the initially calculated MVFs for the 4×4 sub-blocks located at the corners of the CB may be less than ideal. In one example, according to the techniques of this disclosure, inter prediction unit 214 may be configured such that the initially calculated MVFs for the 4×4 sub-blocks located at the corners of the CB are not overwritten with respective collocational control points. However, it should be noted that AF_MERGE mode in JEM may be based on an assumption that the initially calculated MVFs for the 4×4 sub-blocks located at the corners of the CB are overwritten with respective collocational control points. In this manner, inter prediction unit 214 may be configured such that in the case where the initially calculated MVFs for the 4×4 sub-blocks located at the corners of the CB are not overwritten with respective collocational control points, the calculation of v₀ and v₁ in AF_MERGE mode in JEM may be modified to account for the initially calculated MVFs not being overwritten. In one example, control points (i.e., v₀, v₁, v₂, and v₃) may be stored according to a difference data structure. Further, in one example, inter prediction unit 214 may be configured such that control points (i.e., v₀, v₁, v₂, and v₃) used for AF_MERGE are derived based on MVFs calculated for the 4×4 sub-blocks.

Referring again to FIG. 6, at 1004 inter prediction processing unit 214 performs motion compensation based on the determined motion compensation sub-block sizes and the corresponding affine motion vector fields. In this manner, inter prediction processing unit 214 may be configured to perform affine motion compensation according to the techniques described herein.

As described above, an OBMC process may be performed subsequent to performing affine motion compensation. As illustrated in FIG. 6, inter prediction processing unit 214 may be configured to perform an OBMC process (1012). It should be noted that in other examples, inter prediction processing unit 214 may be configured to determine motion compensation sub-block sizes and the corresponding affine motion vector fields according to techniques other than those described above with respect to FIG. 7 and as such the OBMC process described with respect to FIG. 6 may be generally applicable.

Referring to FIG. 6, inter prediction processing unit 214 determines whether the motion compensation sub-block sizes are aligned with an OBMC process (1006). For example, as described above, in some cases the available sub-block sizes for performing motion compensation may include 256×256, 128×128, 64×64, 32×32, 16×16, 8×8, and 4×4 and the granularity of an OBMC process may be 4×4. Thus, if a 4×4 sub-block is used for performing motion compensation and a 4×4 granularity is provided for an OBMC, affine motion compensation may be aligned with the OBMC process. It should be noted that in some examples, an affine motion compensation may be consider aligned with an OBMC process, if sub-block sizes used for motion compensation are within an acceptable threshold of the OBMC granularity. As illustrated in FIG. 6, in the case where an alignment condition is satisfied, the MVFs used for performing the OBMC process may be set to the MVFs used for motion compensation (1008).

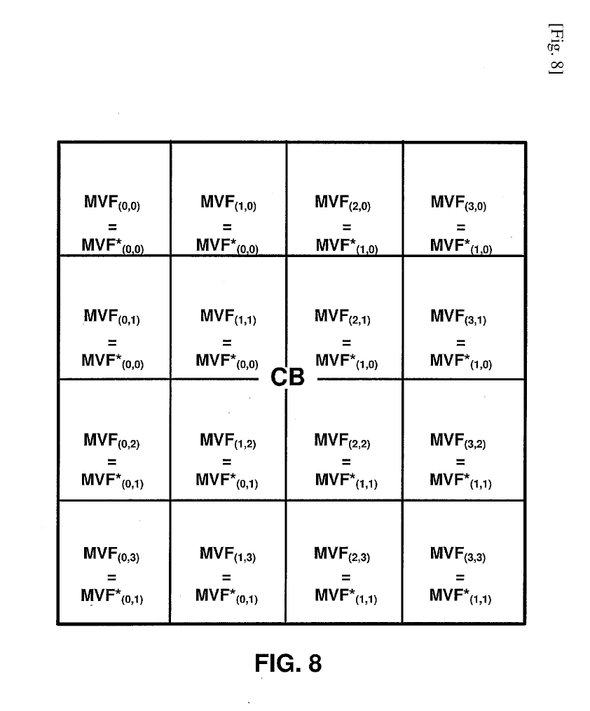

In the case where an alignment condition is not satisfied (e.g., 8×8 MC sub-blocks for motion compensation and a 4×4 OBMC granularity), inter prediction processing unit 214 may determine the OBMC MVFs based on the parameters used for performing motion compensation. For example, as described above with respect to FIG. 7, MVFs for 8×8 sub-blocks of a 16×16 CB may be determined for performing motion compensation. In this case, if the granularity of an OBMC process is 4×4, a MVF for each 4×4 sub-block may be determined based on the MVFs used for motion compensation. FIG. 8 illustrates an example where each 4×4 sub-block corresponding to a OBMC granularity inherits the MVF of a collocated 8×8 sub-block used for motion compensation. In this case, the inherited MVF is used for performing the OBMC process, e.g., the OBMC process described above with respect to FIG. 4. It should be noted that in other examples, that each 4×4 sub-block may inherit a MVF of collocated 8×8 sub-block and modify the inherited MVF values prior to performing an OBMC process. For example, the inherited MVF values may be rounded, scaled, and/or averaged with other inherited MVF values.

With respect to FIG. 6, it should be noted that in some examples, the process of calculating MVFs for use in affine motion compensation may not necessary include calculating MVFs for 4×4 sub-blocks. For example, if 8×8 sub-blocks are used for motion compensation, the corresponding MVFs may be calculated directly from one or more control motion vectors. In these cases, it may be particularly useful to derive MVFs for an OBMC process based on the MVFs used affine motion compensation.

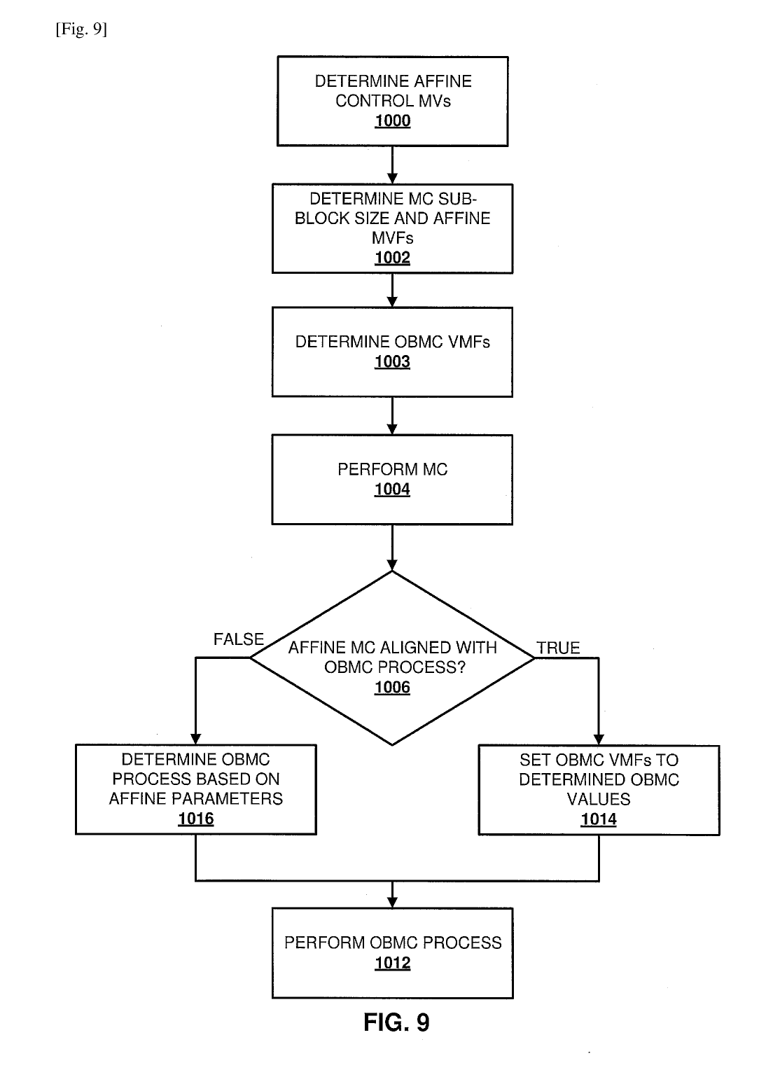

It should be noted that in JEM, MVFs for an OBMC process having a 4×4 granularity are calculated in parallel with determining the size of sub-blocks to be used for affine motion compensation and the corresponding MVFs. Further, in JEM, the calculated MVFs for the OBMC process having a 4×4 granularity are used regardless of the size of the sub-blocks used for affine motion compensation. The JEM implementation may provide undesirable results in cases where the motion compensation sub-block sizes not are aligned with the OBMC process. FIG. 9 illustrates an example techniques that may be used to mitigate the undesirable results.

Referring to FIG. 9, at 1003, MVFs for an OBMC process having a defined granularity are determined, e.g., as described above with respect to FIG. 4. In the example, illustrated in FIG. 9, in the case where an alignment condition is satisfied, the MVFs used for performing the OBMC process at 1012 are set to the values determined at 1003. In the case where an alignment condition is not satisfied, inter prediction processing unit 214 may be configured to determine an OBMC process based on parameters used for performing the affine motion compensation. For example, inter prediction processing unit 214 may be configured to change the granularity of an OBMC process based on the sub-block size and/or shape used for performing motion compensation. It should be noted that in other examples, determining an OBMC process may include determining which sub-blocks within a CB, an OBMC process is applied to (e.g., boundary vs. interior sub-blocks). Further, parameters used for performing the affine motion compensation may include control motion vectors and values based thereon (e.g., Diff₁ and/or Diff₂). In one example, a sub-block size used for affine motion compensation may be used to determine which rows and/or columns of sub-blocks (or lines within a CB) are modified according to an OBMC technique. For example, if width*height of an affine motion compensation sub-block is greater than 64, 4 lines near the CB boundary may be modified, otherwise 2 lines near a CB boundary may be modified. In this manner, inter prediction processing unit 214 may be configured modify a OBMC process based on affine motion compensation parameters.

Referring again to FIG. 5, filter unit 216 receives reconstructed video blocks and coding parameters and outputs modified reconstructed video data. Filter unit 216 may be configured to perform deblocking and/or Sample Adaptive Offset (SAO) filtering. SAO filtering is a non-linear amplitude mapping that may be used to improve reconstruction by adding an offset to reconstructed video data. It should be noted that as illustrated in FIG. 5, intra prediction processing unit 212 and inter prediction processing unit 214 may receive modified reconstructed video block via filter unit 216. Entropy encoding unit 218 receives quantized transform coefficients and predictive syntax data (i.e., intra prediction data, motion prediction data, QP data, etc.). It should be noted that in some examples, coefficient quantization unit 206 may perform a scan of a matrix including quantized transform coefficients before the coefficients are output to entropy encoding unit 218. In other examples, entropy encoding unit 218 may perform a scan. Entropy encoding unit 218 may be configured to perform entropy encoding according to one or more of the techniques described herein. Entropy encoding unit 218 may be configured to output a compliant bitstream, i.e., a bitstream that a video decoder can receive and reproduce video data therefrom.

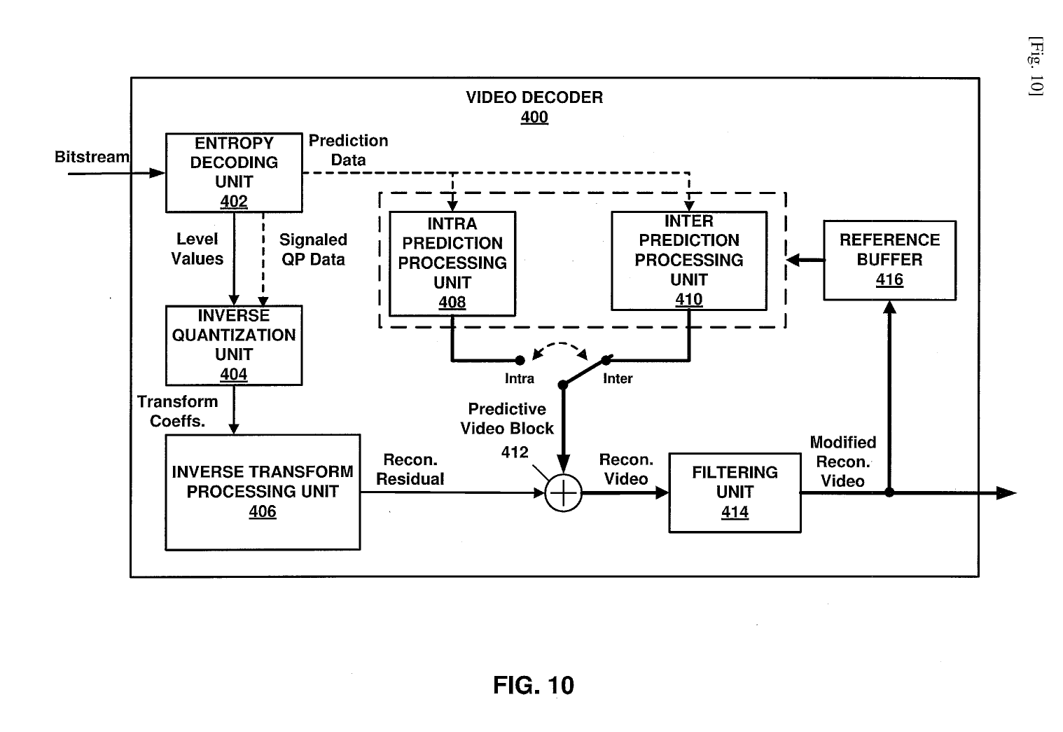

FIG. 10 is a block diagram illustrating an example of a video decoder that may be configured to decode video data according to one or more techniques of this disclosure. In one example, video decoder 400 may be configured to inter prediction techniques based on one or more of the techniques described above. It should be noted that video encoder 200 may signal syntax elements in a bitstream indicating coding parameters for reconstructed video data based on the inter prediction techniques described above. In this manner, video decoder 400 may receive a bitstream generated based on the techniques described above and perform a reciprocal coding process to generate reconstructed video data.

Video decoder 400 may be configured to perform intra prediction decoding and inter prediction decoding and, as such, may be referred to as a hybrid decoder. In the example illustrated in FIG. 10 video decoder 400 includes an entropy decoding unit 402, inverse quantization unit 404, inverse transform processing unit 406, intra prediction processing unit 408, inter prediction processing unit 410, summer 412, filter unit 414, reference buffer 416, and scaling unit 418. Video decoder 400 may be configured to decode video data in a manner consistent with a video encoding system, which may implement one or more aspects of a video coding standard. It should be noted that although example video decoder 400 is illustrated as having distinct functional blocks, such an illustration is for descriptive purposes and does not limit video decoder 400 and/or sub-components thereof to a particular hardware or software architecture. Functions of video decoder 400 may be realized using any combination of hardware, firmware, and/or software implementations.

As illustrated in FIG. 10, entropy decoding unit 402 receives an entropy encoded bitstream. Entropy decoding unit 402 may be configured to decode syntax elements and quantized coefficients from the bitstream according to a process reciprocal to an entropy encoding process. Entropy decoding unit 402 may be configured to perform entropy decoding according any of the entropy coding techniques described above. Entropy decoding unit 402 may parse an encoded bitstream in a manner consistent with a video coding standard.

Referring again to FIG. 10, inverse quantization unit 404 receives quantized transform coefficients (i.e., level values) and quantization parameter data from entropy decoding unit 402. Quantization parameter data may include any and all combinations of delta QP values and/or quantization group size values and the like described above. Video decoder 400 and/or inverse quantization unit 404 may be configured to determine quantization values used for inverse quantization based on values signaled by a video encoder and/or through video properties and/or coding parameters. That is, inverse quantization unit 404 may operate in a reciprocal manner to coefficient quantization unit 206 described above. Inverse quantization unit 404 may be configured to apply an inverse quantization. Inverse transform processing unit 406 may be configured to perform an inverse transformation to generate reconstructed residual data. The techniques respectively performed by inverse quantization unit 404 and inverse transform processing unit 406 may be similar to techniques performed by inverse quantization/transform processing unit 208 described above. Inverse transform processing unit 406 may be configured to apply an inverse DCT, an inverse DST, an inverse integer transform, Non-Separable Secondary Transform (NSST), or a conceptually similar inverse transform processes to the transform coefficients in order to produce residual blocks in the pixel domain. Further, as described above, whether particular transform (or type of particular transform) is performed may be dependent on an intra prediction mode. As illustrated in FIG. 10, reconstructed residual data may be provided to summer 412. Summer 412 may add reconstructed residual data to a predictive video block and generate reconstructed video data. A predictive video block may be determined according to a predictive video technique (i.e., intra prediction and inter frame prediction).

Intra prediction processing unit 408 may be configured to receive intra prediction syntax elements and retrieve a predictive video block from reference buffer 416. Reference buffer 416 may include a memory device configured to store one or more frames of video data. Intra prediction syntax elements may identify an intra prediction mode, such as the intra prediction modes described above. In one example, intra prediction processing unit 408 may reconstruct a video block using according to one or more of the intra prediction coding techniques describe herein. Inter prediction processing unit 410 may receive inter prediction syntax elements and generate motion vectors to identify a prediction block in one or more reference frames stored in reference buffer 416. Inter prediction processing unit 410 may produce motion compensated blocks, possibly performing interpolation based on interpolation filters. Identifiers for interpolation filters to be used for motion estimation with sub-pixel precision may be included in the syntax elements. Inter prediction processing unit 410 may use interpolation filters to calculate interpolated values for sub-integer pixels of a reference block. Inter prediction processing unit 410 may be configured to perform inter prediction coding according to techniques described herein. For example, inter prediction processing unit 410 may perform inter prediction decoding in reciprocal manner to processes performed by inter prediction processing unit 214 as described above. Filter unit 414 may be configured to perform filtering on reconstructed video data according to the techniques described herein. For example, filter unit 414 may be configured to perform deblocking and/or SAO filtering, as described above with respect to filter unit 216 and filter unit 300. Further, it should be noted that in some examples, filter unit 414 may be configured to perform proprietary discretionary filter (e.g., visual enhancements). As illustrated in FIG. 10, a reconstructed video block may be output by video decoder 400.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

### OVERVIEW

In one example, a method of performing motion compensation comprises receiving an array of sample values included in a video block, determining motion vector fields for sub-blocks within the video block and performing a motion compensation process based on the determined motion vector fields.

In one example, a device for video coding comprises one or more processors configured to receive an array of sample values included in a video block, determine motion vector fields for sub-blocks within the video block and perform motion compensation process based on the determined motion vector fields.

In one example, a non-transitory computer-readable storage medium comprises instructions stored thereon that, when executed, cause one or more processors of a device to receive an array of sample values included in a video block, determining motion vector fields for sub-blocks within the video block and perform a motion compensation process based on the determined motion vector fields.

In one example, an apparatus comprises means for receiving an array of sample values including adjacent reconstructed video blocks for a component of video data, means for receiving an array of sample values included in a video block, means for determining motion vector fields for sub-blocks within the video block, and means performing a motion compensation process based on the determined motion vector fields.

The details of one or more examples are set forth in the accompanying drawings and the description below. Unless explicitly stated otherwise, components and functions are optional and may be combined or subdivided, and operations may vary in sequence or may be combined or subdivided. Other features, objects, and advantages will be apparent from the description and drawings, and from the claims.

### CROSS REFERENCE

This Nonprovisional application claims priority under 35 U.S.C. § 119 on provisional Application No. 62/406,396 on Oct. 10, 2016 and provisional Application No. 62/440,326 on Dec. 29, 2016, the entire contents of which are hereby incorporated by reference.

1-12. (canceled)

13. A method of performing motion compensation, the method comprising:
receiving an array of sample values included in a first video block;
determining motion vector fields for sub-blocks within the first video block;
performing a motion compensation process, for the first video block, based on the determined motion vector fields for sub-blocks within the first video block; and
determining the size of sub-blocks to be used for performing motion compensation, wherein determining the size of sub-blocks to be used for performing motion compensation includes determining the size based on a predetermined value.

14. The method of claim 13, wherein the predetermined value is indicated according to a hierarchical signaling.

15. The method of claim 13, further comprising:
determining motion vector fields for sub-blocks within a second video block, based on the motion vector fields determined for the sub-blocks within the first video block; and
performing a motion compensation process, for the second video block, based on the motion vector fields determined for the second video block.

16. A device for performing motion compensation, the device comprising one or more processors configured to:
receive an array of sample values included in a first video block;
determine motion vector fields for sub-blocks within the first video block;
perform a motion compensation process, for the first video block, based on the determined motion vector fields for sub-blocks within the first video block; and
determine the size of sub-blocks to be used for performing motion compensation, wherein determining the size of the sub-blocks to be used for performing motion compensation includes determining the size based on a predetermined value.

17. The device of claim 16, wherein the predetermined value is indicated according to a hierarchical signaling.

18. The device of claim 16, the device further comprising one or more processors configured to:
determine motion vector fields for sub-blocks within a second video block, based on the motion vector fields determined for the sub-blocks within the first video block; and
perform a motion compensation process, for the second video block, based on the motion vector fields determined for the second video block.

19. The device of claim 16, wherein the device includes a video encoder.

20. The device of claim 16, wherein the device includes a video decoder.

21. An apparatus for coding video data, the apparatus comprising means for performing any and all combinations of the steps of claim 13.

22. A non-transitory computer-readable storage medium comprising instructions stored thereon that, when executed, cause one or more processors of a device for coding video data to perform any and all combinations of the steps of claim 13.

23. A method of performing motion compensation, the method comprising:
receiving an array of sample values included in a first video block;
determining motion vector fields for sub-blocks within the first video block; and
performing a motion compensation process based on the determined motion vector fields for sub-blocks within the first video block, wherein determining the motion vector fields for sub-blocks within the first video block includes determining a set of motion vector fields for a first sub-block size, and the motion compensation process is performed based on a second sub-block size.

24. The method of claim 23, further comprising:
determining the motion vector fields for the sub-blocks within the second video block, based on the motion vector fields determined for the sub-blocks within the first video block; and
performing a motion compensation process, for the second video block, based on the motion vector fields determined for the second video block.

25. The method of claim 23, further comprising determining the size of sub-blocks to be used for performing motion compensation.

26. The method of claim 23, wherein determining the size of sub-blocks to be used for performing motion compensation includes determining the size based on a predetermined value.

27. The method of claim 23, wherein the predetermined value is indicated according to a hierarchical signaling.

28. A device for performing motion compensation, the device comprising one or more processors configured to:
receive an array of sample values included in a first video block;
determine the motion vector field for the sub-blocks within the first video block; and
perform a motion compensation process based on the determined motion vector fields for sub-blocks within the first video block, wherein determining motion vector fields for sub-blocks within the first video block includes determining a set of motion vector fields for a first sub-block size, and the motion compensation process is performed based on a second sub-block size.

29. The device of claim 28, the device further comprising one or more processors configured to:
determine the motion vector fields for the sub-blocks within a second video block, based on the motion vector fields determined for the sub-blocks within the first video block; and
perform a motion compensation process, for the second video block, based on the motion vector fields determined for the second video block.

30. The device of claim 28, wherein the device includes a video encoder.

31. The device of claim 28, wherein the device includes a video decoder.

32. A non-transitory computer-readable storage medium comprising instructions stored thereon that, when executed, cause one or more processors of a device for coding video data to perform any and all combinations of the steps of claim 23.
